(19) United States
(12) Patent Application Publication
(10) Pub. No.: US 2024/0257164 A1
(43) Pub. Date: Aug. 1, 2024

(54) DATABASE VALUE PREDICTION

(71) Applicant: International Business Machines Corporation, Armonk, NY (US)

(72) Inventors: Matthew Harrison Tong, Austin, TX (US); Apoorva Nitsure, Pittsburgh, PA (US); Rajesh Bordawekar, Westchester, NY (US)

(73) Assignee: International Business Machines Corporation, Armonk, NY (US)

(21) Appl. No.: 18/103,820

(22) Filed: Jan. 31, 2023

(51) Int. Cl. G06Q 30/0202; G06F 16/2455

(52) U.S. Cl. CPC G06Q 30/0202; G06F 16/24564

(57) ABSTRACT

Tokenized rows of a training portion of a database are selected, each of the selected tokenized rows having a first token value stored in a first column of the database. Training row vectors are grouped into clusters. From the clusters, prototypes are generated, each prototype comprising a numerical representation of a cluster. From input tokens, an input row vector is generated, the input row vector comprising a numerical representation of input tokens representing data in an input row of the database, the input row excluded from the training portion, each input token comprising a textual representation of data in a cell of the input row. Based on similarity with the input row vector, a prototype is selected. Data derived from the selected prototype is inserted into the first column of the input row.

### BACKGROUND

The present invention relates generally to a method, system, and computer program product for databases. More particularly, the present invention relates to a method, system, and computer program product for database value prediction.

A database is an organized collection of data, generally stored and accessed electronically from a computer system. A database management system is software that allows users and applications to interact with data in the database, including entry, storage, retrieval, and organization of that data. The database, database management system, and any associated applications are referred to collectively as a database system.

Many database systems organize data according to a relational model and are referred to as relational database systems. A relational model organizes data into one or more tables, or relations, of columns and rows. Generally, each table represents one entity type (such as customers or products). Rows, also called records or tuples, in a table represent instances of that type of entity (such as a particular customer or particular product). Columns, also called attributes, in a table represent attributes of a particular instance (such as an address or price). Thus, an intersection of a row and a column (also called a cell) holds a value attributed to an instance (such as a particular customer's address or the price of a particular product).

In some database systems, each row in each table has its own unique key, called a primary key. Each primary key selects one and only one row in a table, for access and possible modification. Thus, each primary key also represents a particular row in a table. By adding a column for the primary key of a linked row into another table, primary keys are used to define relationships among tables. Primary keys are typically system-assigned integers, to enforce uniqueness and allow for efficient data access.

Typical database queries request particular data—for example, all sales for a particular day of a particular product in a particular region—and the database returns records from the database that match the query. Semantic or cognitive queries are queries involving not just the stored data, but the meaning of the stored data. Some examples of semantic queries are similarities (i.e., what other database entries are similar to a particular entry), dissimilarities (i.e., what other entries are dissimilar to a particular entry), and analogies (i.e., what entry has the same relationship to C as A does to B).

### SUMMARY

The illustrative embodiments provide a method, system, and computer program product. An embodiment includes a method that selects a plurality of tokenized rows of a training portion of a database, each of the selected tokenized rows having a first token value stored in a first column of the database. An embodiment groups, into a plurality of clusters, a plurality of training row vectors, each training row vector in the plurality of training row vectors comprising a numerical representation of a row of training tokens, each row of training tokens representing data in a selected row, each training token comprising a textual representation of data in a cell of the database. An embodiment generates, from the plurality of clusters, a plurality of prototypes, each prototype comprising a numerical representation of a cluster. An embodiment generates, from a plurality of input tokens, an input row vector, the input row vector comprising a numerical representation of input tokens representing data in an input row of the database, the input row excluded from the training portion, each input token comprising a textual representation of data in a cell of the input row. An embodiment selects, based on similarity with the input row vector, a prototype. An embodiment inserts, into the first column of the input row, data derived from the selected prototype.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for database value prediction in accordance with an illustrative embodiment;

FIG. 3 depicts an example of database value prediction in accordance with an illustrative embodiment;

FIG. 4 depicts a continued example of database value prediction in accordance with an illustrative embodiment;

FIG. 5 depicts a continued example of database value prediction in accordance with an illustrative embodiment;

FIG. 6 depicts a continued example of database value prediction in accordance with an illustrative embodiment;

FIG. 7 depicts a flowchart of an example process for database value prediction in accordance with an illustrative embodiment.

### DETAILED DESCRIPTION

The illustrative embodiments recognize that presently available database query systems support semantic queries that reference existing data in the database. For example, similarity, dissimilarity, and analogy queries all request existing data from the database. It is also useful to be able to execute queries involving new data, not yet incorporated into a database. Filling in missing database entries, detecting mistakes in database data, and classifying database entries (e.g., identifying fraudulent transactions in a database holding transaction data), are all examples of useful queries involving new data. Generating new data is also referred to as predicting new data. However, the illustrative embodiments recognize that presently available database query systems that support queries involving new data rely on performing comparisons with existing database rows, and thus have performance that does not scale well with database size, requiring unacceptably long times to respond to a query once a database grows larger than a particular size.

The illustrative embodiments also recognize that, for improved usability and model management, one model that executes queries involving new as well as existing data is desirable. Users also desire a model that is both flexible (without the need for targeted training for each kind of prediction or type of data) and is able to explain the reasoning leading to a particular model result. Thus, the illustrative embodiments recognize that there is a need for a model that executes queries involving new as well as existing data, with performance that scales well with database size, and that is flexible and produces explainable results.

The illustrative embodiments recognize that the presently available tools or solutions do not address these needs or provide adequate solutions for these needs. The illustrative embodiments used to describe the invention generally address and solve the above-described problems and other problems related to database value prediction.

An embodiment can be implemented as a software application. The application implementing an embodiment can be configured as a modification of an existing database system, as a separate application that operates in conjunction with an existing database system, a standalone application, or some combination thereof.

Particularly, some illustrative embodiments provide a method that selects a plurality of tokenized rows of a training portion of a database, each of the selected rows having a first token value stored in a first column of the database. The method generates, from a plurality of clusters of vectors representing the selected rows, a plurality of prototypes, and inserts, into the first column of an input row, data derived from a selected prototype.

An embodiment receives as input record data of a database, arranged in rows and columns. Alternatively, input record data may be in a different format but rearrangeable into a row-column format. Columns in a table are also called attributes. Each row-column intersection in a table holds a value. Thus, a row can also be considered to hold a series of attribute-value pairs. One column, or attribute, is assigned to store the primary key of each row. Thus, the primary key of a particular row also has a value and can also be considered an attribute-value pair.

An embodiment generates tokens corresponding to one or more attribute-value pairs in rows of the database. Each token is a textual representation of data in an attribute-value pair (a cell) of the database. In one embodiment, a token is a text string including a textual representation of an attribute and a textual representation of the data in a cell (an attribute-value intersection) of the database. In one embodiment, a training token includes one or more separator characters (e.g., “!”, “_”, or a space character) between the textual representation of an attribute and the textual representation of the data. For example, a token representing the attribute MERCHANT with the value STORE-A might be MERCHANT!!STORE-A, and a token representing the attribute ITEMS with the value BANANAS might be ITEMS!!BANANAS. If the cell value is numerical, one embodiment converts the numerical value to corresponding to text. For example, a token representing the attribute AMOUNT with the value 40 might be AMOUNT!!40. Another embodiment assigns numerical cell values to one of a set of labelled numerical ranges, and uses the label of the assigned range as part of the token. For example, the value 40 might be assigned to the range labelled C1, which includes values 35-45, and hence a token representing the attribute AMOUNT with the value 40 might be AMOUNT!!C1. Other token implementations, including a format other than a text string, other representations of attribute, value, and separator, and other data included in each token, are also contemplated within the scope of the exemplary embodiments.

An embodiment selects a plurality of tokenized rows of a training portion of the database. Each of the selected tokenized rows has the same token stored in a column of the database for which prediction is to be performed.

An embodiment uses an embedding model to generate, from a token in a selected row, a corresponding vector representation, also known as a vector or an embedding. A vector, as used herein, is a set of real numbers within a fixed range. The number of real numbers in the set—also called the dimension—is also fixed. As a non-limiting example, one commonly used dimension is 320, and each real number is between −1 and 1. Other dimensions and ranges are also possible and contemplated within the scope of the illustrative embodiments. Each unique token corresponds to a unique vector. The token-to-vector conversion is configured such that one can measure similarity between two tokens by measuring the similarity between one vector corresponding to one of the tokens and a second vector corresponding to the second token. An embodiment includes an embedding model trained to implement a token-to-vector conversion. Techniques to train the embedding model are presently available.

One non-limiting method of measuring vector similarity is cosine similarity, which computes similarity between two non-zero vectors by measuring the cosine of the angle between the two vectors. In particular, cosine similarity can be computed using the expression sum (AᵢBᵢ)/sum (Aᵢ²) sum (Bᵢ²), where the sum( ) function denotes the sum of the term inside the parentheses, using all integer values of i from 1 to n, and Aᵢ and Bᵢ are components of vector A and B respectively.

This example of a method for determining similarity is not intended to be limiting. From this disclosure, those of ordinary skill in the art will be able to conceive other ways with which to determine similarity and the same are contemplated within the scope of the illustrative embodiments. For example, similarity between two vectors can also be determined by computing a distance between the two vectors (the difference between two vectors v and w is the length of the difference vector v−w). The vectors with the least distance between each other are the most similar vectors. For example, the Euclidian distance between two vectors v and w is the length of the line segment connecting v and w. The Manhattan distance between two vectors v and w is the sum of the absolute differences of the Cartesian coordinates of each of v and w. Generalizations of both Euclidian and Manhattan distances are also possible, and additional distance or similarity measures are also applicable to measure similarity between vectors.

An embodiment also generates row vectors corresponding to tokens representing one or more attribute-value pairs in a row. Each row vector is a numerical representation of tokens in a row of a database, and thus represents a row of the database. One embodiment generates a row vector by computing a weighted average of vectors generated from tokens in the row. Weights in the weighted average are selected based on statistics of the tokens—for example, one embodiment weights vectors based on their smooth inverse frequency (SIF), which is alpha/(alpha+p(token)), where alpha is a smoothing constant and p(token) is the frequency of occurrence of a particular token. One embodiment excludes a token for a column to be predicted from the row vector by setting that column's weight to zero when computing the row vector using a weighted average. Another embodiment uses an embedding model to generate row vectors directly, without using token-specific vectors.

An embodiment groups row vectors representing rows in the training portion of the database into clusters, and generates one or more prototypes representing a particular cluster. In particular, an embodiment, for each n of N unique tokens in a column, executes a clustering technique to generate k prototypes for that token for the subset of rows where the attribute (column label) is equal to n and k is a predetermined constant. One embodiment uses the k-means clustering technique, a presently available technique that aims to partition data points into clusters, in which each data point belongs to the cluster with the nearest mean to the data point. K-means and other clustering techniques are also usable to compute statistics of the generated clusters, such as cluster means.

A prototype is a representative of a cluster, and provides a useful way to describe a cluster by describing typical data in a cluster. In one embodiment, each prototype is a numeric centroid, or mean, of a cluster, and there is one prototype per cluster. In another embodiment, each cluster is represented by one or more prototypes which are exemplars, data points (i.e., vectors representing training rows) closest to a cluster's centroid. Another embodiment constructs a prototype from the most likely values for each column, or attribute, of data, based on statistics of the cluster. For example, if above a threshold percentage of the rows within a cluster have the “teacher” value in the “occupation” column, then the cluster's constructed prototype includes the occupation!!teacher token in the prototype's “occupation” column. As another example, if values in the “occupation” column have approximately an even split between “teacher”, “lawyer”, and “doctor”, the cluster might have all three listed as likely values for occupation for that prototype.

An embodiment generates tokens corresponding to one or more attribute-value pairs in an input row of the database, on which predictions are to be made. An input row is a row that was excluded from the training portion of the database, and hence was not included in the cluster and prototype generation described herein. Each token is a textual representation of data in an attribute-value pair (a cell) of the database. An embodiment generates tokens from an input row in the same manner described herein as tokens were generated from rows in the training portion. An embodiment uses the same embedding model as used for the training portion to generate a corresponding vector representation of a token in an input row in the same manner as used for rows in the training portion. An embodiment generates input row vectors, row vectors corresponding to tokens representing one or more attribute-value pairs in a row, in the same manner as used for rows in the training portion.

An embodiment selects, based on similarity to an input row vector, one or more prototypes. One embodiment selects one or more prototypes that are most similar to an input row vector, as determined by a similarity measurement technique described herein. An embodiment uses data derived from a column of the selected prototype(s) to generate a prediction for a corresponding column in the input row. One embodiment maintains a set of prototypes for each token (a column-value pair), and stores the corresponding token with each prototype for use as the prediction. For example, there might be twenty prototype vectors for Occupation!!Teacher (representing data for a prototypical teacher) and twenty for Occupation!!Lawyer (representing data for a prototypical lawyer). Predictions are useful to fill in missing data in a database cell (e.g., an amount of product in a particular transaction), to classify data in a row (e.g., a column of the database might be a classification label, classifying transaction data in the row as fraudulent or not fraudulent), and to identify possible mistakes in data (e.g., if a prediction for a database cell differs by more than a threshold amount from data currently in the database cell, there might be an error in the data currently in the database cell and additional review might be necessary). Prototypes themselves are also useful to describe typical aspects of data in a database that are different from one another. In particular, if only one prototype is selected, an embodiment uses the prototype's corresponding token as the prediction, and inserts the generated prediction at the appropriate row-column intersection. If more than one prototype is selected, one embodiment averages the prototypes and uses the average's corresponding token as the prediction. If more than one prototype is selected, another embodiment uses the token corresponding to the most-used prototype as the prediction at the appropriate row-column intersection. For example, an embodiment generating a prediction for the BANANAS column of an input row might use, as the prediction, the value in the BANANAS column of the exemplar of the closest prototype to a row vector of the input row. One embodiment outputs one or more prototypes as well. One embodiment outputs one or more predictions in response to a query.

An embodiment uses statistics of the clustering to determine a confidence value in the prediction. An embodiment also uses similarity to one or more prototypes in an explanation of the prediction. For example, an embodiment might produce an explanation that the value range inserted into the input row's BANANAS column was derived from a prototype of a particular cluster, and provide one or more statistical properties of that cluster.

The manner of database value prediction described herein is unavailable in the presently available methods in the technological field of endeavor pertaining to databases. A method of an embodiment described herein, when implemented to execute on a device or data processing system, comprises substantial advancement of the functionality of that device or data processing system in selecting a plurality of tokenized rows of a training portion of a database, each of the selected rows having a first token value stored in a first column of the database. The method generates, from a plurality of clusters of vectors representing the selected rows, a plurality of prototypes, and inserts, into the first column of an input row, data derived from a selected prototype.

The illustrative embodiments are described with respect to certain types of databases, database rows and columns, tokens, vectors, clusters, centroids, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

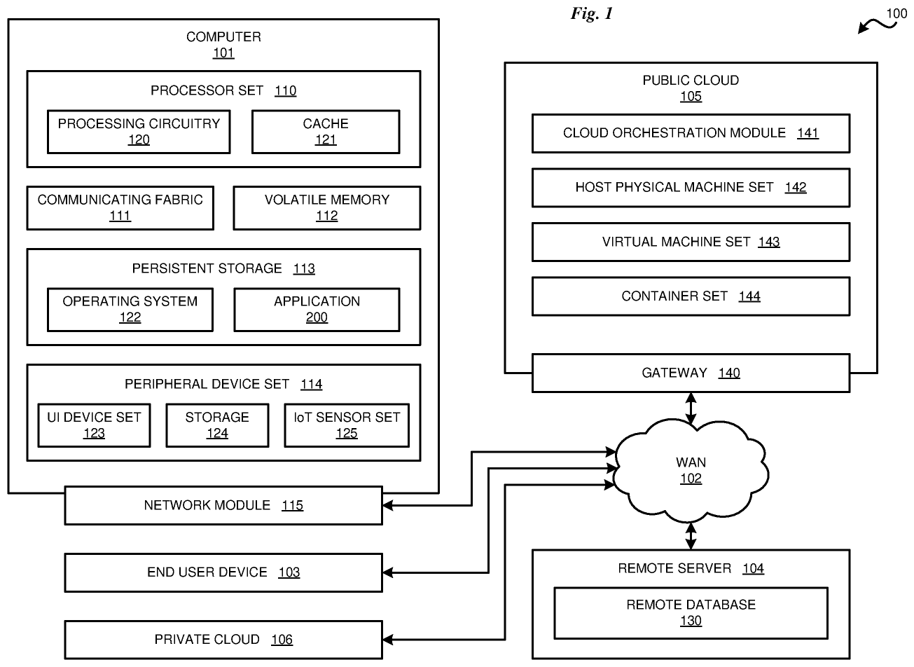

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a database value prediction embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

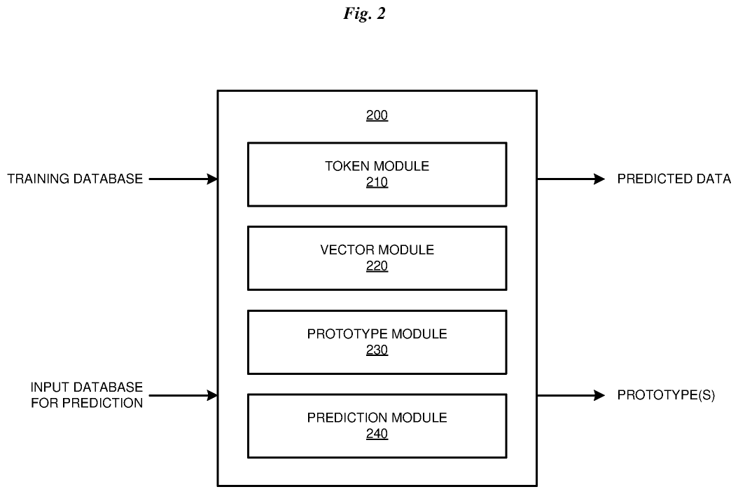

With reference to FIG. 2, this figure depicts a block diagram of an example configuration for database value prediction in accordance with an illustrative embodiment. Application 200 is the same as application 200 in FIG. 1.

Application 200 receives as input record data of a database, arranged in rows and columns. Alternatively, input record data may be in a different format but rearrangeable into a row-column format.

Token module 210 generates tokens corresponding to one or more attribute-value pairs in a row of the database. Each token is a textual representation of data in an attribute-value pair (a cell) of the database. In one implementation of module 210, a token is a text string including a textual representation of an attribute and a textual representation of the data in a cell (an attribute-value intersection) of the database. In one implementation of module 210, a training token includes one or more separator characters (e.g., “!”, “_”, or a space character) between the textual representation of an attribute and the textual representation of the data. For example, a token representing the attribute MERCHANT with the value STORE-A might be MERCHANT!!STORE-A, and a token representing the attribute ITEMS with the value BANANAS might be ITEMS!!BANANAS. If the cell value is numerical, one implementation of module 210 converts the numerical value to corresponding to text. For example, a token representing the attribute AMOUNT with the value 40 might be AMOUNT!!40. Another implementation of module 210 assigns numerical cell values to one of a set of labelled numerical ranges, and uses the label of the assigned range as part of the token. For example, the value 40 might be assigned to the range labelled C1, which includes values 35-45, and hence a token representing the attribute AMOUNT with the value 40 might be AMOUNT!!C1. Other token implementations, including a format other than a text string, other representations of attribute, value, and separator, and other data included in each token, are also possible.

Application 200 selects a plurality of tokenized rows of a training portion of the database. Each of the selected tokenized rows has the same token stored in a column of the database for which prediction is to be performed.

Vector module 220 uses an embedding model to generate, from a token in a selected row, a corresponding vector representation, also known as a vector or an embedding. Each unique token corresponds to a unique vector. The token-to-vector conversion is configured such that one can measure similarity between two tokens by measuring the similarity between one vector corresponding to one of the tokens and a second vector corresponding to the second token. Module 220 includes an embedding model trained to implement a token-to-vector conversion.

Vector module 220 also generates row vectors corresponding to tokens representing one or more attribute-value pairs in a row. Each row vector is a numerical representation of tokens in a row of a database, and thus represents a row of the database. One implementation of module 220 generates a row vector by computing a weighted average of vectors generated from tokens in the row. Weights in the weighted average are selected based on statistics of the tokens—for example, one embodiment weights vectors based on their smooth inverse frequency. One implementation of module 220 excludes a token for a column to be predicted from the row vector by setting that column's weight to zero when computing the row vector using a weighted average. Another implementation of module 220 uses an embedding model to generate row vectors directly, without using token-specific vectors.

Prototype module 230 groups row vectors representing rows in the training portion of the database into clusters, and generates one or more prototypes representing a particular cluster. In particular, module 230, for each n of N unique tokens in a column, executes a clustering technique to generate k prototypes for that token for the subset of rows where the attribute (column label) is equal to n and k is a predetermined constant. One implementation of module 230 uses the k-means clustering technique, a presently available technique that aims to partition data points into clusters, in which each data point belongs to the cluster with the nearest mean to the data point. K-means and other clustering techniques are also usable to compute statistics of the generated clusters, such as cluster means.

A prototype is a representative of a cluster, and provides a useful way to describe a cluster by describing typical data in a cluster. In one implementation of module 230, each prototype is a numeric centroid, or mean, of a cluster, and there is one prototype per cluster. In another implementation of module 230, each cluster is represented by one or more prototypes which are exemplars, data points (i.e., vectors representing training rows) closest to a cluster's centroid. Another implementation of module 230 constructs a prototype from the most likely values for a particular column, or attribute, of data, based on statistics of the cluster. For example, if above a threshold percentage of the rows within a cluster have the “teacher” value in the “occupation” column, then the cluster's constructed prototype includes the occupation!!teacher token in the prototype's “occupation” column. As another example, if values in the “occupation” column have approximately an even split between “teacher”, “lawyer”, and “doctor”, the cluster might have all three listed as likely values for occupation for that prototype.

Token module 210 generates tokens corresponding to one or more attribute-value pairs in an input row of the database, on which predictions are to be made. An input row is a row that was excluded from the training portion of the database, and hence was not included in the cluster and prototype generation described herein. Each token is a textual representation of data in an attribute-value pair (a cell) of the database. Module 210 generates tokens from an input row in the same manner described herein as tokens were generated from rows in the training portion. Vector module 220 uses the same embedding model as used for the training portion to generate a corresponding vector representation of a token in an input row in the same manner as used for rows in the training portion. Vector module 220 generates input row vectors, row vectors corresponding to tokens representing one or more attribute-value pairs in a row, in the same manner as used for rows in the training portion. However, when generating input row vectors, module 220 does not include a token for a column to be predicted. One implementation of module 220 excludes a token for a column to be predicted from the row vector by setting that column's weight to zero when computing the row vector using a weighted average.

Prediction module 240 selects, based on similarity to an input row vector, one or more prototypes. One implementation of module 240 selects one or more prototypes that are most similar to an input row vector, as determined by a similarity measurement technique described herein. Module 240 uses data derived from a column of the selected prototype(s) to generate a prediction for a corresponding column in the input row. One implementation of application 200 maintains a set of prototypes for each token (a column-value pair), and stores the corresponding token with each prototype for use as the prediction. For example, there might be twenty prototype vectors for Occupation!!Teacher (representing data for a prototypical teacher) and twenty for Occupation!!Lawyer (representing data for a prototypical lawyer). Predictions are useful both to fill in missing data in a database cell (e.g., an amount of product in a particular transaction) and to classify data in a row (e.g., a column of the database might be a classification label, classifying transaction data in the row as fraudulent or not fraudulent), and to identify possible mistakes in data (e.g., if a prediction for a database cell differs by more than a threshold amount from data currently in the database cell, there might be an error in the data currently in the database cell and additional review might be necessary. Prototypes themselves are also useful to describe typical aspects of data in a database that are different from one another. In particular, if only one prototype is selected, module 240 uses the prototype's corresponding token as the prediction, and inserts the generated prediction at the appropriate row-column intersection. If more than one prototype is selected, one implementation of module 240 averages the prototypes and uses the average's corresponding token as the prediction. If more than one prototype is selected, another implementation of module 240 uses the token corresponding to the most-used prototype as the prediction at the appropriate row-column intersection. For example, module 240, generating a prediction for the BANANAS column of an input row, might use, as the prediction, the value in the BANANAS column of the exemplar of the closest prototype to a row vector of the input row. One implementation of application 200 outputs one or more prototypes as well. One implementation of application 200 outputs one or more predictions in response to a query.

Prediction module 240 uses statistics of the clustering to determine a confidence value in the prediction. Prediction module 240 also uses similarity to one or more prototypes in an explanation of the prediction. For example, module 240 might produce an explanation that the value range inserted into the input row's BANANAS column was derived from a prototype of a particular cluster, and provide one or more statistical properties of that cluster.

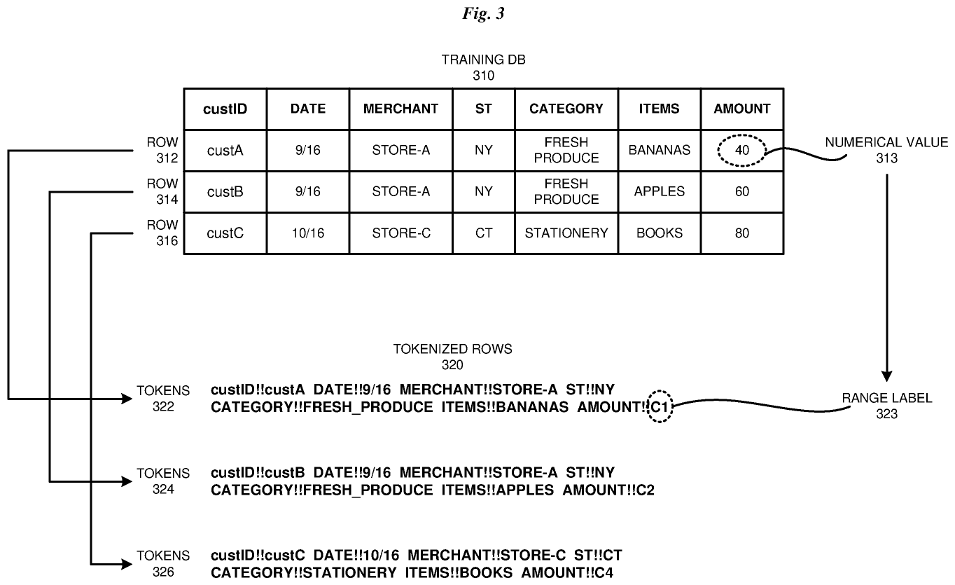

With reference to FIG. 3, this figure depicts an example of database value prediction in accordance with an illustrative embodiment. The example can be executed using application 200 in FIG. 2.

As depicted, training database (DB) 310 includes rows 312, 314, and 316. Rows 312, 314, and 316 are tokenized to tokens 322, 324, and 326 respectively. Tokens 322, 324, and 326 are all part of tokenized rows 320. Note that during tokenization, numerical values (e.g., numerical value 313) are tokenized using range labels (e.g., range label 323).

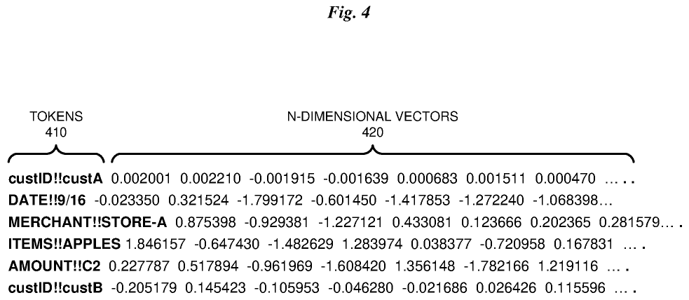

With reference to FIG. 4, this figure depicts a continued example of database value prediction in accordance with an illustrative embodiment. The example can be executed using application 200 in FIG. 2.

In particular, FIG. 4 depicts tokens 410 (from one or more of tokens 322, 324, and 326 in FIG. 3) and their corresponding n-dimensional vectors 420.

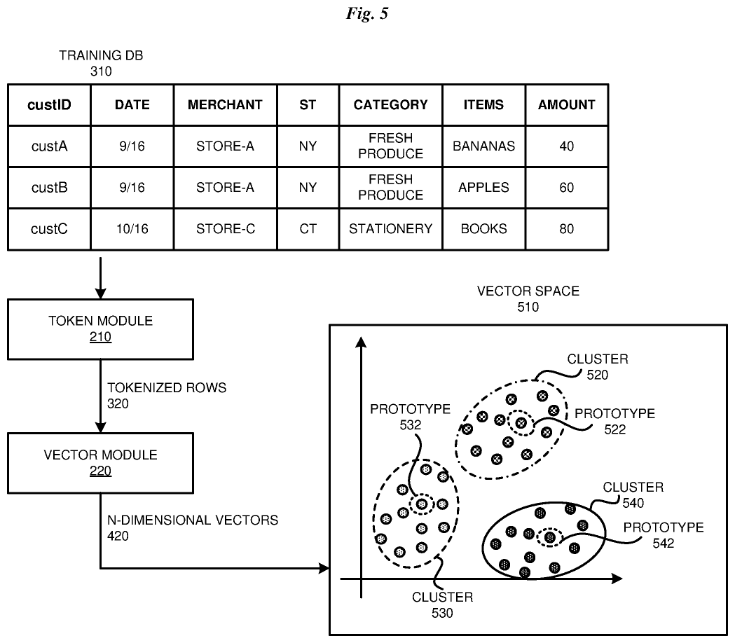

With reference to FIG. 5, this figure depicts a continued example of database value prediction in accordance with an illustrative embodiment. Token module 210 and vector module 220 are the same as token module 210 and vector module 220 in FIG. 2. Training DB 310 and tokenized rows 320 are the same as training DB 310 and tokenized rows 320 in FIG. 3. N-dimensional vectors 420 is the same as n-dimensional vectors 420 in FIG. 4.

Token module 210 generates tokenized rows 320 from the rows in training DB 310. Vector module 220 generates n-dimensional vectors 420 from tokenized rows 320.

Prototype module 230 in FIG. 2 groups n-dimensional vectors 420, training row vectors, into clusters, for example clusters 520, 530, and 540. The clusters are depicted in vector space 510. Prototypes 522, 532, and 542 represent clusters 520, 530, and 540 respectively.

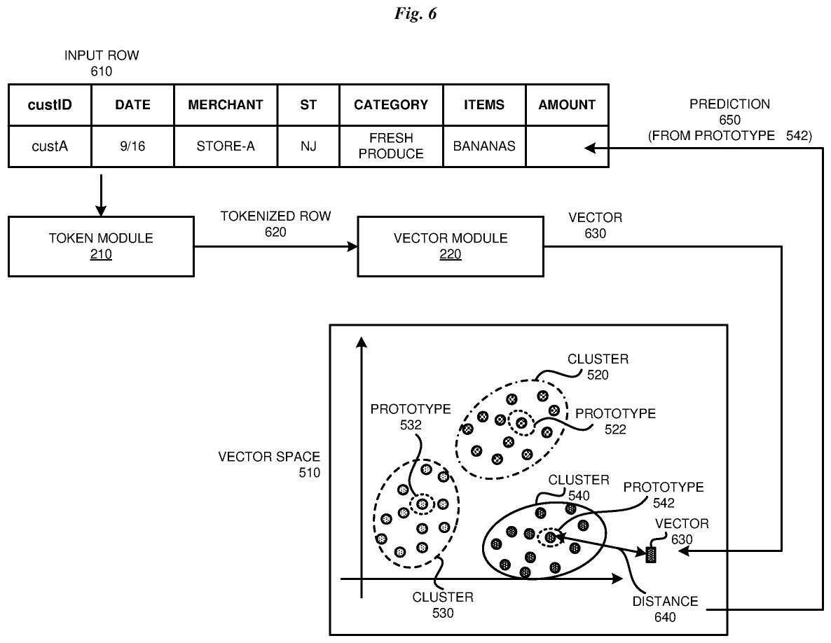

With reference to FIG. 6, this figure depicts a continued example of database value prediction in accordance with an illustrative embodiment. Token module 210 and vector module 220 are the same as token module 210 and vector module 220 in FIG. 2. Vector space 510, clusters 520, 530, and 540, and prototypes 522, 532, and 542 are the same as vector space 510, clusters 520, 530, and 540, and prototypes 522, 532, and 542 in FIG. 5.

Token module 210 generates tokenized row 620 from input row 610, a row in an input database. Vector module 220 generates vector 630 from tokenized row 620. Vector 630, mapped into vector space 510, is at distance 640 from prototype 542, the closet prototype to vector 630. Thus, prototype 542 is used to generate prediction 650 in the AMOUNT column of input row 610.

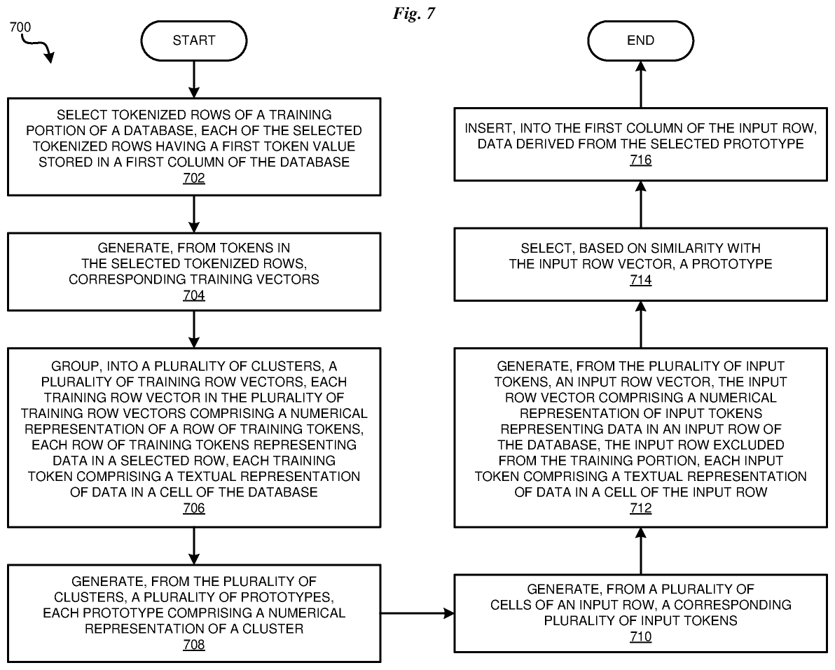

With reference to FIG. 7, this figure depicts a flowchart of an example process for database value prediction in accordance with an illustrative embodiment. Process 700 can be implemented in application 200 in FIG. 2.

In block 702, the application selects tokenized rows of a training portion of a database, each of the selected tokenized rows having a first token value stored in a first column of the database. In block 704, the application generates, from tokens in the selected tokenized rows, corresponding training vectors. In block 706, the application groups, into a plurality of clusters, a plurality of training row vectors, each training row vector in the plurality of training row vectors comprising a numerical representation of a row of training tokens, each row of training tokens representing data in a selected row, each training token comprising a textual representation of data in a cell of the database. In block 708, the application generates, from the plurality of clusters, a plurality of prototypes, each prototype comprising a numerical representation of a cluster. In block 710, the application generates, from a plurality of cells of an input row, a corresponding plurality of input tokens. In block 712, the application generates, from the plurality of input tokens, an input row vector, the input row vector comprising a numerical representation of input tokens representing data in an input row of the database, the input row excluded from the training portion, each input token comprising a textual representation of data in a cell of the input row. In block 714, the application selects, based on similarity with the input row vector, a prototype. In block 716, the application inserts, into the first column of the input row, data derived from the selected prototype. Then the application ends.

Thus, a computer implemented method, system or apparatus, and computer program product are provided in the illustrative embodiments for database value prediction and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
selecting a plurality of tokenized rows of a training portion of a database, each of the selected tokenized rows having a first token value stored in a first column of the database;
grouping, into a plurality of clusters, a plurality of training row vectors, each training row vector in the plurality of training row vectors comprising a numerical representation of a row of training tokens, each row of training tokens representing data in a selected row, each training token comprising a textual representation of data in a cell of the database;
generating, from the plurality of clusters, a plurality of prototypes, each prototype comprising a numerical representation of a cluster;
generating, from a plurality of input tokens, an input row vector, the input row vector comprising a numerical representation of input tokens representing data in an input row of the database, the input row excluded from the training portion, each input token comprising a textual representation of data in a cell of the input row;
selecting, based on similarity with the input row vector, a prototype; and
inserting, into the first column of the input row, data derived from the selected prototype.

2. The computer-implemented method of claim 1, further comprising:
generating, from a plurality of cells of the training portion, a corresponding plurality of training tokens.

3. The computer-implemented method of claim 2, further comprising:
generating, from the plurality of training tokens, a corresponding plurality of training vectors, each training vector comprising a numerical representation of a training token.

4. The computer-implemented method of claim 1, wherein the plurality of prototypes each comprise a centroid of a cluster in the plurality of clusters.

5. The computer-implemented method of claim 1, wherein the plurality of prototypes each comprise a row vector closest to a centroid of a cluster in the plurality of clusters.

6. The computer-implemented method of claim 1, wherein the selected prototype is a prototype most similar to the input row vector.

7. A computer program product comprising one or more computer readable storage medium, and program instructions collectively stored on the one or more computer readable storage medium, the program instructions executable by a processor to cause the processor to perform operations comprising:
selecting a plurality of tokenized rows of a training portion of a database, each of the selected tokenized rows having a first token value stored in a first column of the database;
grouping, into a plurality of clusters, a plurality of training row vectors, each training row vector in the plurality of training row vectors comprising a numerical representation of a row of training tokens, each row of training tokens representing data in a selected row, each training token comprising a textual representation of data in a cell of the database;
generating, from the plurality of clusters, a plurality of prototypes, each prototype comprising a numerical representation of a cluster;
generating, from a plurality of input tokens, an input row vector, the input row vector comprising a numerical representation of input tokens representing data in an input row of the database, the input row excluded from the training portion, each input token comprising a textual representation of data in a cell of the input row;
selecting, based on similarity with the input row vector, a prototype; and
inserting, into the first column of the input row, data derived from the selected prototype.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
generating, from a plurality of cells of the training portion, a corresponding plurality of training tokens.

11. The computer program product of claim 10, further comprising:
generating, from the plurality of training tokens, a corresponding plurality of training vectors, each training vector comprising a numerical representation of a training token.

12. The computer program product of claim 7, wherein the plurality of prototypes each comprise a centroid of a cluster in the plurality of clusters.

13. The computer program product of claim 7, wherein the plurality of prototypes each comprise a row vector closest to a centroid of a cluster in the plurality of clusters.

14. The computer program product of claim 7, wherein the selected prototype is a prototype most similar to the input row vector.

15. A computer system comprising a processor and one or more computer readable storage media, and program instructions collectively stored on the one or more computer readable storage media, the program instructions executable by the processor to cause the processor to perform operations comprising:
selecting a plurality of tokenized rows of a training portion of a database, each of the selected tokenized rows having a first token value stored in a first column of the database;
grouping, into a plurality of clusters, a plurality of training row vectors, each training row vector in the plurality of training row vectors comprising a numerical representation of a row of training tokens, each row of training tokens representing data in a selected row, each training token comprising a textual representation of data in a cell of the database;
generating, from the plurality of clusters, a plurality of prototypes, each prototype comprising a numerical representation of a cluster;
generating, from a plurality of input tokens, an input row vector, the input row vector comprising a numerical representation of input tokens representing data in an input row of the database, the input row excluded from the training portion, each input token comprising a textual representation of data in a cell of the input row;
selecting, based on similarity with the input row vector, a prototype; and
inserting, into the first column of the input row, data derived from the selected prototype.

16. The computer system of claim 15, further comprising:
generating, from a plurality of cells of the training portion, a corresponding plurality of training tokens.

17. The computer system of claim 16, further comprising:
generating, from the plurality of training tokens, a corresponding plurality of training vectors, each training vector comprising a numerical representation of a training token.

18. The computer system of claim 15, wherein the plurality of prototypes each comprise a centroid of a cluster in the plurality of clusters.

19. The computer system of claim 15, wherein the plurality of prototypes each comprise a row vector closest to a centroid of a cluster in the plurality of clusters.

20. The computer system of claim 15, wherein the selected prototype is a prototype most similar to the input row vector.
